(19) United States
(12) Patent Application Publication
(10) Pub. No.: US 2017/0076036 A1
(43) Pub. Date: Mar. 16, 2017

(54) PROTEIN FUNCTIONAL AND SUB-CELLULAR ANNOTATION IN A PROTEOME

(71) Applicants: Konstantinos Theofilatos, PATRA (GR); Christos Dimitrakopoulos, BASEL (CH); Seferina Mavroudi, PATRA (GR); Aigli Korfiati, PATRA (GR); Christos Alexakos, PATRA (GR)

(72) Inventors: Konstantinos Theofilatos, PATRA (GR); Christos Dimitrakopoulos, BASEL (CH); Seferina Mavroudi, PATRA (GR); Aigli Korfiati, PATRA (GR); Christos Alexakos, PATRA (GR)

(73) Assignee: InSyBio Ltd, Winchester (GB)

(21) Appl. No.: 15/361,461

(22) Filed: Nov. 27, 2016

(51) Int. Cl. G06F 19/18; G06N 99/00; G06N 7/00

(52) U.S. Cl. CPC G06F 19/18; G06N 7/005; G06N 99/005

(57) ABSTRACT

Techniques are disclosed for identifying the likely functionality and sub-cellular localization of individual proteins by first creating a protein-protein interaction network where protein pairs are created from data available from databases and experimental results, and by guessing potential interacting protein pairs where no data exists. Inside each protein pair, mutual likely functionality and localization annotations are made using the known functionalities and localization of the two proteins. The resulting annotated proteins are clustered according to similarity of their annotations and for each cluster iterative mutual annotations in each protein pair enrich the previous functional annotations until no more functionality annotations can be made and results in proteins with at least one assigned functionality and localization duet. Ranking of the resulting assignments is done using the specificity and confidence of the assignment.

### BACKGROUND

Field

The present invention relates to techniques for predicting the function of proteins, and in particular, materials, software, automated computing systems, and related methods for functionally characterizing proteins using a computational framework.

Background

Finding the protein functionality is considered an open problem until now, even if many researchers have already been involved in this task. Existing experimental techniques accompanied with the indispensable analytical methods have achieved to characterize functionally a large amount of proteins. However, experimental methods are time-ineffective and costly and thus require additional time-effective computational methods to expand their coverage and to validate experimental findings reducing their error rates.

The creation of numerous experimental and computational methods for the prediction of trustworthy protein-protein interactions has enabled the possibility to predict the protein functionalities. For this purpose, many methods have been developed, categorized to those that predict protein functionality using sequential, structural and evolutionary information and those that use protein-protein interaction networks.

The first category of algorithmic approaches is based on the protein homology and their sequential similarities. They follow the principle that proteins with high sequential similarity have probably evolved from a common ancestor and they should have similar functionality. It has been proven that at least 40% of sequential similarity is required to assign a catalytic functionality to a protein, while this percentage is raised to 60% for substrate functionalities. The most successful methodology for predicting proteins functionality based on homology is the Rosetta Stone. In general, the predictions that are based on homology present limited applicability as they cannot be applied to many proteins. In particular, they cannot be applied to proteins which do not have a known homologous protein or do not have a homologous protein with known functionality. Moreover, homologue-based predictions present high error rates. The tool GOPET utilizes Support Vector Machines to classify homology-based predictions as correct or erroneous. It gets as input some metrics of sequence similarity, frequency of Gene Ontology terms, quality of metadata for the homologous proteins and metadata in Gene Ontology for these proteins. This methodology increases the accuracy of protein functionality prediction based on homology.

Another category of algorithms for the prediction of proteins functionality is the one that is based on searching for certain structural patterns within the structure of a protein. The searched patterns have already been linked with specific functionalities. One approach is to propose a complete methodology to predict protein functionality using functionally characterized structural parts of proteins. PROSITE is a well-defined database which includes functionally characterized structural motifs. Another similar database is PRINTS. Both of them include sequential protein motifs which have been experimentally associated with specific functionalities. The Annolite database includes structural motifs that allow for the prediction of proteins functionality having as input only their sequence. This database compares the structural parts of every examined protein with other functionally characterized motifs and calculates a probability for every protein to perform specific functions. The tool PHUNCTIONER searches for conservative structural parts of proteins to characterize proteins with Gene Ontology terms.

Another category of methods for the prediction of protein functionality is the one that is based on microarray experiments. When clustering algorithms are applied on gene expression data, the genes that participate in the same metabolic paths tend to be grouped together. A metric has been proposed that is based on gene expression and it has been shown that genes related to the same functionalities are co-expressed. Many similar methods have been proposed in the literature. For example, if an uncharacterized gene is grouped in a cluster of genes that are responsible for cholesterol metabolism, then we can safely conclude that this gene is related with this functionality. However, the accurate deduction of protein functionalities using these methods remains problematic until now.

The utilization of evolutionary, sequential and structural information of proteins alongside with their expression profiles for inferring protein functionality has presented satisfactory results, but failed to capture the complex intracellular organization mechanisms. Many algorithms that use protein-protein interaction networks for the prediction of protein functionality have been proposed in order to take advantage of this information. These methods are split into the direct and the indirect ones. The direct methods attempt to predict protein functionality directly from the PPI network, while the indirect methods tackle this task by applying clustering on the deduced PPI graphs.

The common principle that rules direct methods (or neighborhood methods) is that neighboring proteins in the PPI network share common functionality with high probability. Thus, there exists an apparent association between the distance of two proteins in a network and the functionality distance of two proteins.

The prediction of protein functionalities was conducted using the known functionalities of their direct neighborhoods and the annotated functionalities were ordered in descending order based on their frequencies of appearance. The correct prediction rate was found to be 72%. One of the problems of this algorithmic approach is that it ignores the size of the functional classes and thus tends to assign more frequently the more general functionalities. To deal with this problem, a methodology was proposed, which takes into account the organization of functionalities. In this methodology, the functionality of a protein in the PPI network is assigned according to the functionality of its neighbors in distance n (parameter assigned by the user). The protein structure is assigned with the functionality with the highest scores in the neighborhood with distance n. The score of every function is calculated in a way that assigns lower scores to more general functionalities. However, this method presents two basic disadvantages: it does not take into account the global PPI network topology and it is only effective in assigning very generic or very specific functions. To deal with the second constraint, other researchers studied the correlation between the functional similarity and the networks distance. They focused only on the 1st and 2nd distance neighbors and they introduced the functional similarity score which assigned proteins similar scores by using their distance from the protein target. This approach presented increased accuracy when indirect interactions where used to associate a functionality with a protein target.

Indirect methods operate in two phases: First they extract protein clusters from the PPI network and then they use these clusters to characterize them functionally with increased statistical importance. The uncharacterized proteins are then assigned with a functionality based on the clusters that they participate. The most important algorithms for predicting protein functionality with this general methodology are the Majority Vote Prediction Algorithm (MVPA) and the Hypergeometric Distribution Prediction Algorithm (HDPA). The MVPA counts the proteins with the same functionality within a cluster. The three more frequent functionalities are returned as the algorithm's output. HAD utilizes the hypergeometric distribution to estimate if a cluster is enriched with a specific functional category more than expected by chance. The indirect methods can take advantage of the local structural characteristics of PPI networks and for this reason they have presented very encouraging results.

Despite the promising results of existing methodologies, there does not exist an algorithm or tool that can fully functionally characterize the proteins of an examined organism until now. One reason for this is that there do not exist any methods which take into account sequential, structural, evolutionary, and gene expression data alongside with the local and global characteristics of biological networks. Moreover, even if such a method existed, it would not be sufficient for predicting the functionality of every single protein. In the present patent we describe a universal algorithmic framework for this task.

Nowadays, the prediction of protein sub-cellular localization is also considered an open problem. Experimental prediction of protein's sub-cellular localization is considered time ineffective, expensive and its accuracy is surpassed by computational methods which have been designed for this task.

Most computational methods for the prediction of protein's sub-cellular localization are based on conservative features and sequential motifs (such as DNA binding motifs) which have been characterized as being active in specific sub-cellular compartments. These methods use algorithms from the computational intelligence field (Artificial Neural Networks, Support Vector Machines and so on) and their results have reached up to 90% accuracy. However, their performance can be improved as conservative features and sequential motifs cannot provide the required information to predict the sub-cellular localization of proteins for which only a small proportion (less than 30%) of their features is known. Moreover, these features are organism specific and thus different tools and methods are required for different organisms. To overcome this difficulty some methods have been proposed which combine various independent predictors to act in more than one organism. Even if these methods have partially solved the problem, more general methodologies are needed to improve the prediction performance and to raise the number of proteins with known sub-cellular localization in the organisms for which this knowledge is partial.

### SUMMARY

The present disclosure is directed to techniques for predicting the functions of approximately all proteins of an examined organism alongside with the cellular compartments where they are active. Such information is useful, for example, for identifying new genes, understanding the cellular function and the mechanisms which lead to diseases, and thus for identifying potential targets for pharmaceutical compounds.

In one embodiment, the invention describes a holistic framework to analyze protein-protein interactions from simply examining every single protein, predicting their interactions and the complexes that they form till achieving to functionally characterize almost all proteins of an examined organism.

In another embodiment, the invention provides a methodology which is able to functionally characterize all proteins within an examined organism when having as input a protein-protein interaction network and a set of functionally characterized proteins. To achieve this goal, the overall methodology is applying iterative expansion steps which take advantage of the edges in the protein-protein interaction network to infer the function of proteins which are near other proteins with known functionality.

In yet another embodiment, the invention describes an integrative approach which incorporates many existing methodologies for the prediction of protein functionality to improve the initial coverage of proteins with known functionality. These methodologies include the prediction of protein's function using public available databases alongside with the prediction of protein function through clustering approaches in protein-protein interaction graphs and through examining the neighborhood of these graphs.

One embodiment provides a methodology to rank the predicted protein functions ordering them by specificity and their confidence score. This is an extremely significant invention as the end users are able to have a quick view of the most important protein functionality in every specificity layer. Multiple functionalities for every protein are expected and welcome as most proteins are able to perform multiple functionalities in cells.

Another embodiment provides a methodology to predict the cellular compartments where every protein is active. This is accomplished by the same methodology using sub-cellular localization terms instead of molecular function terms to characterize proteins.

### BRIEF DESCRIPTION OF THE DRAWINGS

FIG. 1 shows the main steps of the Proteome's Functional Characterization.

FIG. 2 describes functional characterization of proteins and clustering.

FIG. 3 shows the construction of a Protein-Protein Interaction Graph (PPIG).

FIG. 4 shows functional characterization and ranking of proteins.

FIG. 5 illustrates an example iterative protein clustering and functional characterization.

FIG. 6 shows a system implementing the present invention.

FIG. 7 shows the architecture of a device which implements the invention or part or parts of the invention.

FIG. 8a shows the main Software Components of a mobile device.

FIG. 8b shows the main Software Components of a Server.

FIG. 9 presents, for exemplary purposes, the final functional annotation of NAD-dependent protein deacetylase sirtuin-1 with uniprot-ID E9PC49 which was previously annotated with none of the molecular function, biological process and cellular compartment terms in the gene ontology repository.

### DETAILED DESCRIPTION

The word “exemplary” is used herein to mean “serving as an example, instance, or illustration”. Any embodiment described herein as “exemplary” is not necessarily to be construed as preferred or advantageous over other embodiments.

The terms “cellular” and intercellular” may be used interchangeably where combined with the word “component” or its plural form and refer to the same element(s).

The terms “functional assignment” and “functional characterization” are used interchangeably and have the same meaning.

The terms “topological assignment” and “topological characterization” are used interchangeably and have the same meaning.

The acronym “GO” is intended to mean “Gene Ontology”.

The term “mobile device” may be used interchangeably with “client device” and “device with wireless capabilities”.

The following terms have the following meanings when used herein and in the appended claims. Terms not specifically defined herein have their art recognized meaning.

An “amino acid” is a molecule having the structure wherein a central carbon atom (the α-carbon atom) is linked to a hydrogen atom, a carboxylic acid group (the carbon atom of which is referred to herein as a “carboxyl carbon atom”), an amino group (the nitrogen atom of which is referred to herein as an “amino nitrogen atom”), and a side chain group, R. When incorporated into a peptide, polypeptide, or protein, an amino acid loses one or more atoms of its amino acid carboxylic groups in the dehydration reaction that links one amino acid to another. As a result, when incorporated into a protein, an amino acid is referred to as an “amino acid residue.”

“Protein” refers to any polymer of two or more individual amino acids (whether or not naturally occurring) linked via a peptide bond, and occurs when the carboxyl carbon atom of the carboxylic acid group bonded to the α-carbon of one amino acid (or amino acid residue) becomes covalently bound to the amino nitrogen atom of amino group bonded to the α-carbon of an adjacent amino acid. The term “protein” is understood to include the terms “polypeptide” and “peptide” (which, at times may be used interchangeably herein) within its meaning. In addition, proteins comprising multiple polypeptide subunits (e.g., DNA polymerase III, RNA polymerase II) or other components (for example, an RNA molecule, as occurs in telomerase) will also be understood to be included within the meaning of “protein” as used herein. Similarly, fragments of proteins and polypeptides are also within the scope of the invention and may be referred to herein as “proteins.”

“Protein-protein interactions” (PPIs) are defined as functional or physical interactions among two proteins.

“Protein Complex” is defined as a set of proteins which physically group together to form a more complex structure in order to perform specific functionalities.

“Molecular function” is the term which is used to describe cellular activities that occur at the molecular level.

“Cellular compartments” in biology are defined as parts within a eukaryotic cell, usually surrounded by a single or layer membrane. Most cellular compartments are membrane enclosed regions of the cell.

As used herein and in the appended claims, the singular forms “a,” “and,” and “the” include plural referents unless the context clearly dictates otherwise. Thus, for example, reference to “a protein” includes a plurality of proteins and reference to “protein-protein interactions” generally includes reference to one or more interactions and equivalents thereof known to those skilled in bioinformatics and/or molecular biology.

Unless defined otherwise, all technical and scientific terms used herein have the same meaning as commonly understood to one of ordinary skill in the art to which this invention belongs (systems biology, bioinformatics). Although any methods similar or equivalent to those described herein can be used in the practice or testing of the invention, the preferred methods are described.

All publications mentioned herein are incorporated by reference in full for the purpose of describing and disclosing the databases, proteins, and methodologies, which are described in the publications which might be used in connection with the presently described invention. The publications discussed above and throughout the text are provided solely for their disclosure prior to the filing date of the present application. Nothing herein is to be construed as an admission that the inventors are not entitled to antedate such disclosure by virtue of prior invention.

The present invention treats the problem of accurate, fast, automated, and cost-effective functional characterization of the proteome of an organism. It equally treats the functional characterization of any type of biological molecules, for example, and by no means limited to proteinase, genes, DNA, etc. In the following discussion the use of the terms “protein” or “proteome” can be replaced, in alternative embodiments, with any term meaning, implying, or being equivalent to a biological molecule or collection or group of such molecules or macromolecules e.g. genes/genome and transcripts/transcriptome.

The invention uses any number or type of available scientific data from public or private databases, typically built from experimental results, as well as, results from available methods for predicting the functionality of the entire set of proteins of an organism. The method is capable to iteratively predict and improve on results, thereby assigning one or more functions to any protein and describing the sub-cellular compartment(s) where it is active. This is achieved by creating or using existing protein-protein interaction networks (PPIN), applying machine learning and/or clustering algorithms, and taking into account probabilities, confidence measures, weights and other measures to produce accurate protein functional characterization results. A number of alternative embodiments is presented, which explain the invention in detail and examples of its application in real scenarios are also presented. Illustrations explain the main steps used.

The invention includes an iterative procedure which expands the current knowledge about protein's functionality. This is based on the fact that protein-protein interaction networks due to the small-world phenomenon that holds for them, present a maximum distance of 6 to seven edges between the most distant proteins in them. It is noted that the distance between two nodes in a biological network is defined as the minimum number of edges which constitute the minimum pathway connecting the two nodes. The basic idea for expanding the current knowledge of the protein functional characterization is that if a protein is “near” another protein in the protein-protein interaction network then these proteins have similar functionalities. This idea has been used by many existing methods which functionally characterize proteins with the functional terms of their neighboring proteins with known functionality. Our method, iteratively assigns functionalities to proteins using their functionally characterized neighboring proteins in the protein-protein interaction graph, until all proteins, except the ones which are not connected to the protein-protein interaction graph, are functionally characterized. As an assignment of a function to a protein using this methodology does not guarantee that the protein indeed performs this functionality, its confidence score is reduced with a systematical way which is going to be described in detail.

The invention can be implemented either as a method, a software program implementing the method, or as a microprocessor, or a computer, or a computational device. The description of the invention is presented, for simplicity, in terms of the method implementing it but it is assumed to equally apply to the other forms of implementation previously mentioned.

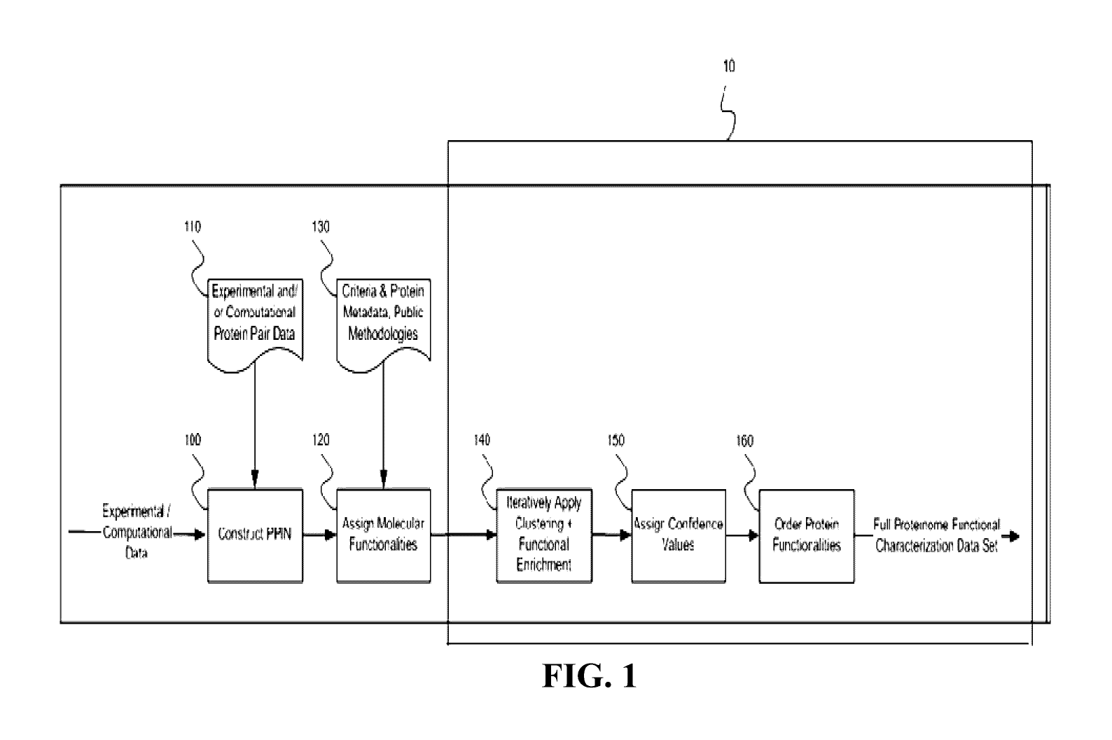

FIG. 1 shows the main steps of the Proteome's Functional Characterization. The input to the invention is a set of experimental data or a set of computational data describing proteins in an organism's proteome, their known interactions with other proteins in the proteome, and the known functions of some of these proteins. In an alternative embodiment, it may include only a subset of the above or may also include sub-cellular compartments where at least some of these proteins are active.

The input data are fed to the first step of the method for Constructing Protein-Protein Interaction Networks (PPIN) 100 where experimental and/or computational data on known or computed (interacting) protein pairs 110 are also fed. These data may be found in public or private databases, such as Gene Ontology, MIPS, etc.

Having created the PPIN 100, the method continues with assigning molecular functionalities 120 to the PPIN members. This initial assignment is done using any available set of criteria, protein metadata and public methodologies 130; these are among those commonly used in the research community (such as 2D or 3D molecular similarity, common segments of biological molecules, distance in the PPIN, etc.) and are obvious to any person skilled in relevant art. Such a person is also knowledgeable of methods for PPIN construction and sources of experimental and computational data.

The assigned molecular functionality data 120 are then clustered together according to any chosen set of criteria, for instance, and by no way limiting the proposed embodiment, using the distance between proteins or some other criterion.

The clustering based approaches, predict protein clusters within the protein-protein interaction networks which should be as close to the protein complexes as possible. When these clusters are predicted, enrichment analysis is conducted to locate clusters which are enriched by at least one functional term. If a cluster is enriched with some terms then even previously uncharacterized proteins which participate in it should be characterized with this term.

This way the clustered proteins are assigned new functionalities belonging to other proteins in their cluster; this assignment of functionalities may be done, for instance by using a rule, e.g., by simply assigning the most significant or all protein functions of proteins in the cluster to each protein in the same cluster. This assignment step may result in previously unassigned proteins to be assigned the functionality or set of functionalities of a protein in their cluster, or in proteins that already had an assigned functionality to be assigned with an additional functionality, that of a member protein in their cluster. This clustering and functional enrichment step may be iteratively applied 140 to the entire proteome to ensure that all proteins have a functional assignment, and to produce results of higher accuracy as during each iteration, assignments are adapted and enriched. This may lead to proteins being assigned several functions as these are calculated based on the clustering and a number of criteria or methods that are used.

Alternative embodiments of this step 140 may be used where any type or number of known (e.g. those described in the background section) or new clustering techniques and criteria or parameters are employed. The chosen clustering techniques may, in an exemplary embodiment, comprise some form of machine learning algorithm; for instance artificial neural networks, support vector machines, or random forests may be used. The choice of such techniques in alternative embodiments is beyond the scope of the description of the present invention and is obvious to any reader of ordinary skill in the related art. Their choice is not affecting the novelty of the present invention and is not limiting the scope of protection sought after.

The number of iterations is also not limiting the scope of the invention and various exemplary embodiments may use different iteration numbers. For instance, a first embodiment may use two iterations, while a second embodiment may use a small multiple of the iterations in the first embodiment, and a third embodiment may use a large multiple of the iterations used in the first embodiment. By means of example, a practical maximum number of iterations does not exceed 6 or seven due to the small world phenomenon which governs biological networks and states that the majority of node pairs have distance smaller than 6 within a biological network. The distance between two nodes in a biological network is defined as the minimum number of edges which constitute the minimum pathway connecting the two nodes.

In an alternative embodiments, the above cluster members are enriched with topological terms instead or functional, or with both topological and functional terms.

The results of this step 140 are then assigned confidence values 150, and the calculated protein functionalities for the entire proteome are then ordered 160.

As using these methodologies, functionalities (and/or cellular compartments) are assigned to proteins in a straight forward manner; the terms which are assigned with this procedure should take an increased confidence score. In this exemplary embodiment, the confidence score for these terms is equal to “1”.

In another exemplary embodiment, to increase the accuracy of the initial assignment of functions and cellular compartments to proteins, more than one of these methods are used and the final confidence score for every functional characterization is assigned using the following equation:

c=0.9+0.1*(m/n) (Equation 1)

where:
“c” is the Confidence Score of the respective assignment,
“m” is the number of different methods making this assignment (i.e. the total number of different methods which have made the examined functional assignment), and
“n” is the number of utilized methods (i.e. the total number of deployed methods).

Using equation 1, the confidence score for the assignments of this step are forced to have values from 0.9 to 1 so that they do not lose their high level of confidence.

The ordering of the functional terms which are assigned in every protein is done using two criteria. The first one, which is the most important, ranks the terms due to their specificity. The more specific terms are ranked higher than the more general ones. The second criterion uses the confidence value 150 assigned to each functional assignment. High confidence scores indicate high values of trust for this assignment while lower confidence scores show that this functional characterization is not trustworthy.

The result is a full proteome functional characterization data set, which can be used for any scientific, teaching, commercial, regulatory, or other use. For instance, the output of the present invention may be used for identifying new genes, understanding cellular function and the mechanisms which lead to diseases, and thus for identifying potential targets for pharmaceutical compounds.

In an alternative embodiment, the functional characterization may be replaced by a topological (i.e. the sub-cellular compartment in which a protein is active) characterization, while in a variation of this embodiment, both functional and topological characterizations may be made to the entire set of proteins in the PPIN.

The innovative part of the method described in FIG. 1 is the right part 10 of the figure.

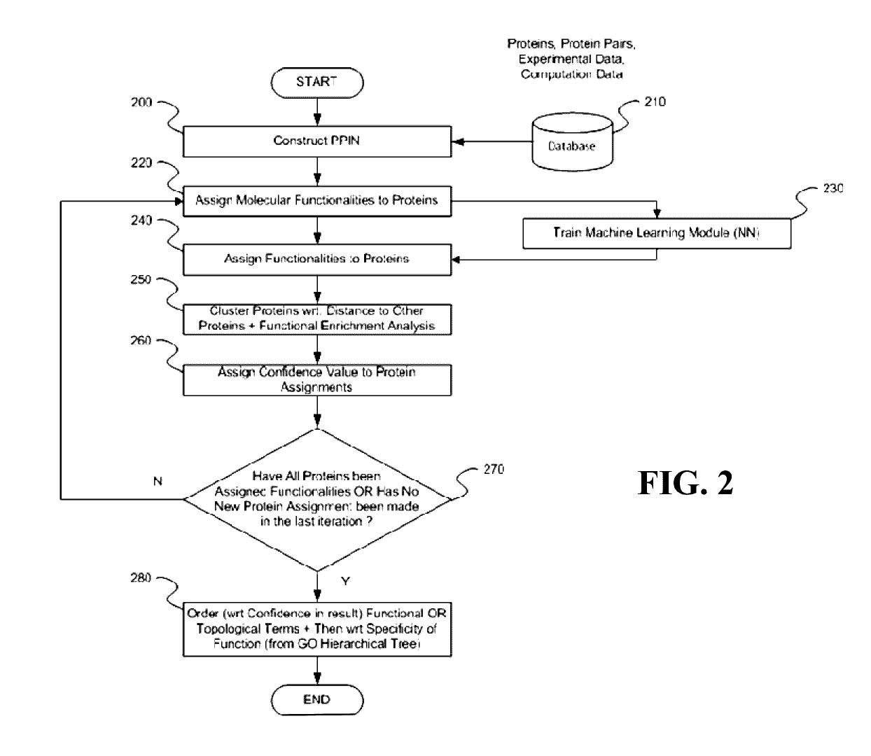

FIG. 2 describes functional characterization of proteins and clustering. It is a more detailed look of the method shown in FIG. 1. A PPIN is constructed 200, using data stored in a database 210. These data comprise Proteins, Protein Pairs, Experimental Data, and Computational Data. The proteins in the PPIN are then assigned molecular functionalities 220.

A machine learning training module is trained 230 using a set of available data; in another embodiment, a subset of the data previously calculated 220 may be used. The trained machine learning module 230 may take any form known to users of ordinary skill in related art. By means of example, the machine learning module may be a Neural Network, a Support Vector Machine, or a Random Forest in different exemplary embodiments.

The method uses the trained machine learning module 230 to assign functionalities to proteins 240 using the previously assigned molecular functionalities 220. The proteins of the PPIN are then clustered with respect to the distance to each other and functional enrichment analysis is used 250 to assign functionalities to those proteins that have no functionalities already assigned to them, or to assign additional functionalities to proteins with already assigned functionalities. This step may again be implemented with any algorithm known to a user of ordinary skill in related art.

The method continuous by assigning confidence values 260 to the previously assigned protein functionalities 240, 250 using the scoring method described by Equation (1). The method iterates the functionality and confidence assignments 220-260 until all proteins in the organism's proteome have been assigned functionalities or no new protein assignment has been made in the last iteration 270.

For the second and all subsequent iterations, the method iteratively characterizes the neighbors of a protein in the PPIN with known functionality (and/or cellular compartment in alternative embodiments) with this known functionality (and/or cellular compartment) which are known before any iterative calculations are made on the original data. However, the confidence score of this characterization (after the first iteration) is set to:

c(i)=c/(1+A) (Equation 2)

where:
“c(i)” is the confidence score of the “i^{th}” iteration assignment
“c” is the confidence score of the known assignment (e.g. derived from one or more databases with functional and/or topological information before the iteration of the method, or corresponding to the “(i−1)” iteration), and
“A” takes values from 0 to 1.

Confidence values (i.e. of “c(i)”) near zero indicate that there is no loss of confidence score if an assignment is conducted in the last iterations. When A is increased then the algorithm reduces the confidence score of the functional (and/or topological) assignment as the iterations increase. When a confidence score of an assignment is below a pre-defined threshold “T” then this assignment is canceled due to low confidence.

In an alternative embodiment, the method assigns topological terms to the proteins in the proteome, i.e. the sub-cellular compartment where each protein is active. It yet another embodiment, the method assigns both function and topological terms to the each protein in the proteome.

Having finished the iterations, the method orders the assigned protein functionalities 280 using the calculated confidence values 260. The ordering (or ranking) of the functional assignments for every protein is done by first organizing the functional terms in either a tree form as the Gene Ontology (GO) terms, or in an hierarchical form as the MIPS terms from the more general to the more specific. The functional assignments are ranked using this organization of the terms. In specific, first are presented the assignments for the more specific group of terms and then follow the assignments for each of the lower specificity group of terms. For every, group of specificity the assignments are ranked from the one with the highest confidence score to the one with the lowest score.

In a variation of this exemplary embodiment, ordering 280 is applied to the topological terms previously assigned to the proteins of the proteome, followed by adapting it to the specificity of the respective functions.

In yet another variation of this exemplary embodiment, ordering 280 is applied first to the functional terms using the calculated confidence values, then adapt it to the corresponding topological terms, and finally adapt it to the specificity function.

An alternative embodiment of the method shown in FIG. 2 constructs a PPIN 200, which is weighted to reflect the significance or importance of each interaction (edge) it contains. In this embodiment, the confidence value 260 of an assignment in every iteration is calculated with the following equation:

c′(i)=c(i)*w_{AB} (Equation 3)

where:
“c′(i)” is the confidence score of assignment for iteration “i” for a protein
“c(i)” is the confidence score of assignment in protein “A” (as calculated by Equation 2)
“w_{AB}” is the weight of the interaction between protein “A” and protein “B”
“A” is the protein with known or assigned functionality in the previous iteration, and
“B” is the neighboring protein of “A”, for which protein “B” the assignment is made on the present iteration “i”.

Using Equation 3 the confidence scores of the assignments are decreased as the iterations rise but they now reflect the confidence of the interactions and the higher level organization of the protein-protein interaction networks. Similar to the exemplary embodiment where the un-weighted PPIN was used, assignments with confidence scores below a pre-defined threshold “T” are canceled. The same value of “T” may be used in both exemplary embodiments, or different threshold values may be selected.

Both alternative embodiments (i.e. with weighted or un-weighted PPIN) terminate in approximately 6 iterations as this is the longest distance in protein-protein interaction networks between the most distant proteins.

The use of the current invention, as described in the previous alternative embodiments, creates results that functionally and topologically characterize the entire set of proteins in a genome of an organism. Nevertheless, there may be a small number of proteins which are not assigned any functionality and/or topology as the choice of the methods used for each step may not provide confident results.

It is noteworthy, that the current invention provides an overall framework to assign multiple functional and topological terms to every protein of an organism under examination. This is extremely important as proteins are known to participate in more than one molecular function and sometimes be active in more than one cellular compartment. Moreover, the proposed ranking scheme is able to provide researchers a full report about the functional and topological characterization of every protein. Even for proteins where little is known until now, researchers are getting a first glance of what may be the role of these proteins in the cells.

In another embodiment, the overall methodology could be implemented using other biological networks such as gene co-expression networks, genetic networks, gene regulatory networks and even metabolic networks. For the cases of gene co-expression networks and genetic networks only an extra step is required; to map genes with the proteins that they produce when they are expressed. When dealing with gene regulatory and metabolic networks an additional variation of the overall methodology should be applied as these networks are directed graphs. In this case, functional assignments 240 of the overall methodology are allowed only on the direction indicated by the directed edges.

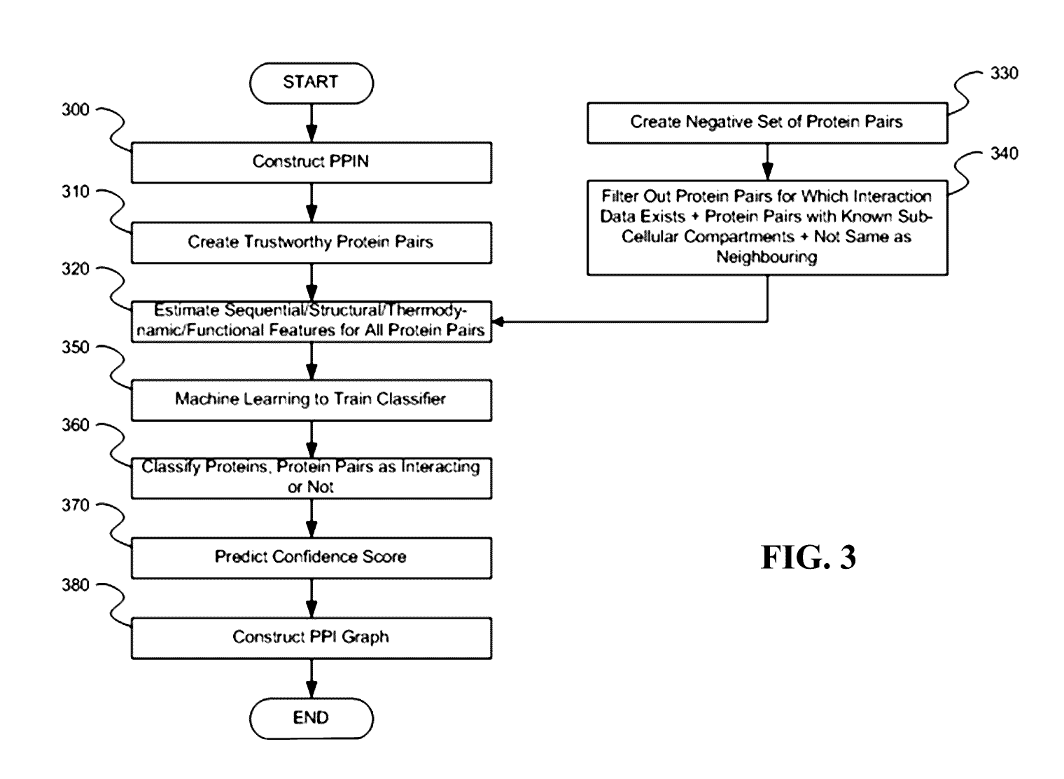

FIG. 3 shows the construction of a Protein-Protein Interaction Graph (PPIG). This is a detailed view of the respective step 100 in FIGS. 1 and 200 in FIG. 2 and shows how a PPIN can be processed to increase its accuracy and enrich it with additional information, effectively converting a small un-weighted PPIN obtained by mostly experimental data into an enriched weighted PPIG with increased coverage on the proteome. The method starts with the construction of the PPIN 300.

The PPIN is constructed by mining experimentally and/or computationally predicted protein-protein interactions and constructing the PPIN using them. A PPIN is constructed using as nodes the proteins of the organism under examination and drawing edges to connect two proteins only when this protein-pair is among the mined interactions. Using this alternative, weights equal to 1 is assigned to all edges.

In an alternative embodiment, the PPIN may be constructed by creating and accumulating a significant amount of trustworthy protein-protein interaction pairs 310, which should be mined from experimental techniques in order to reduce the error rates. A variety of public available databases exist (e.g. HPRD, DIP and so on) that include high quality protein-protein interactions and the positive protein-protein interaction set could be constructed using them.

This is followed by the accumulation of a negative set of protein pairs 330, which includes protein pairs which are not interacting ones. A common practice is to use random protein pairs to construct the negative set as the rate of interacting to non-interacting protein pairs is extremely low and thus only a small insignificant error rate is introduced to the methodology with this approach. However, many improvements of this approach exist and in the current invention, the creation of negative set is implemented by providing an initial set of random protein pairs and filtering out 340 protein pairs that have been referred at least once as an interaction in the literature and protein pairs whose proteins sub-cellular compartments are known and are not the same or neighboring ones.

Once the positive and negative sets are constructed then for every protein pair in them a set of sequential, structural, thermo-dynamical and functional features should be estimated 320. These features comprise common functional terms, similarities of gene expression profiles, whether the two proteins have orthologue interactions in other organisms, structural feasibility of the interaction for proteins with known structure, presence or absence of interacting domains in the proteins, sequence similarity of the two proteins, common post-translational modifications and so on.

When the features have been calculated, machine learning is used to train a classifier 350. By means of example, the training is done using Artificial Neural Networks, Support Vector Machines, or Random Forests. The classification of proteins and proteins pairs as interacting or not 360 is done by the trained classifier and a confidence score is predicted 370 for the classified interactions. The final step of this algorithmic approach is the construction of the Protein-Protein Interaction Graph (PPIG) 380 with proteins as nodes, interactions as edges and a weight equal to the confidence score of the interaction.

The type of machine learning algorithm used and the type of chosen classifier being trained by the machine learning algorithm are beyond the scope of this invention. Any machine learning algorithm and classifier known to any user of ordinary skill in related art can be used and, similarly, any parameters he prefers may be chosen. For pure exemplary reason, an artificial neural network may be trained for machine learning and a Hierarchical Learning Classifier System Flat algorithm (i.e. HLCS-Flat) classifier be chosen.

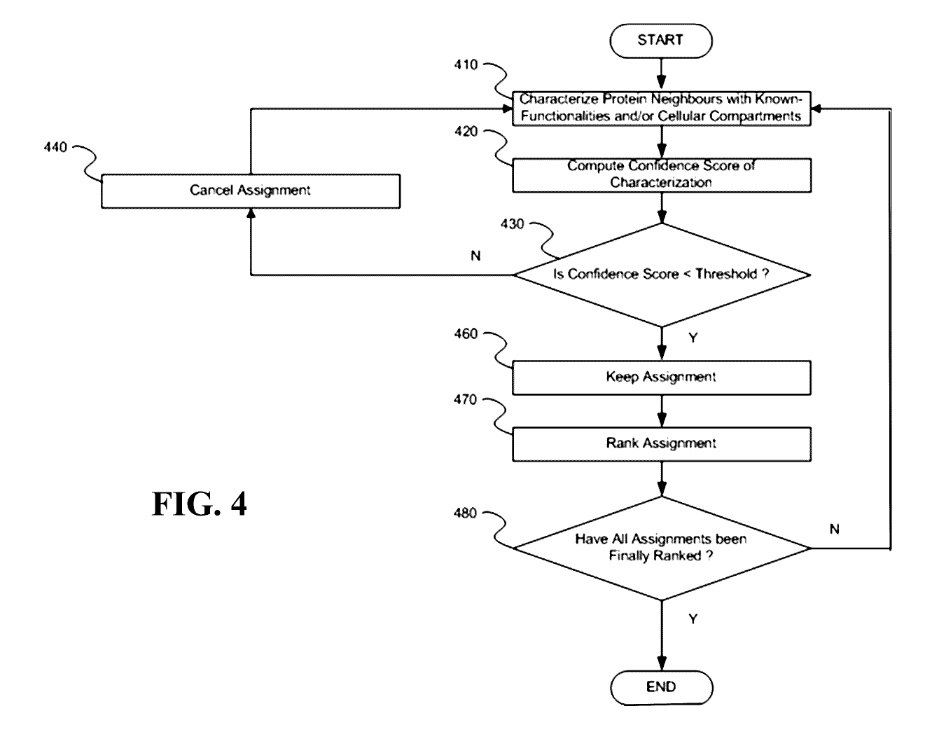

FIG. 4 shows functional characterization and ranking of proteins. It is a more detailed view of the functional characterization, confidence scoring, and ranking steps of the iterative method presented in FIG. 1 and FIG. 2. The method starts by characterizing protein neighbors with known functionalities and/or cellular compartments 410, i.e. assigned with the functionality and/or topology (i.e. cellular compartment where they are active) of their neighbor.

A confidence score is then calculated 420 for this characterization of the neighboring proteins 420, as previously explained. This confidence score 420 is compared against a user-defined threshold (default 0.1) 430. If it is larger or equal to the threshold, the assignment is cancelled 440 and the neighboring proteins characterization step 410 is repeated for different neighboring proteins, followed by the re-calculation of confidence scores 420 and their comparison to the previously used threshold 430.

If the confidence score is smaller than the threshold 430, the assignment is kept 460 and ranked 470 as previously described. The entire method is iterated until all protein assignments have been finally ranked for all proteins in the PPIG 480.

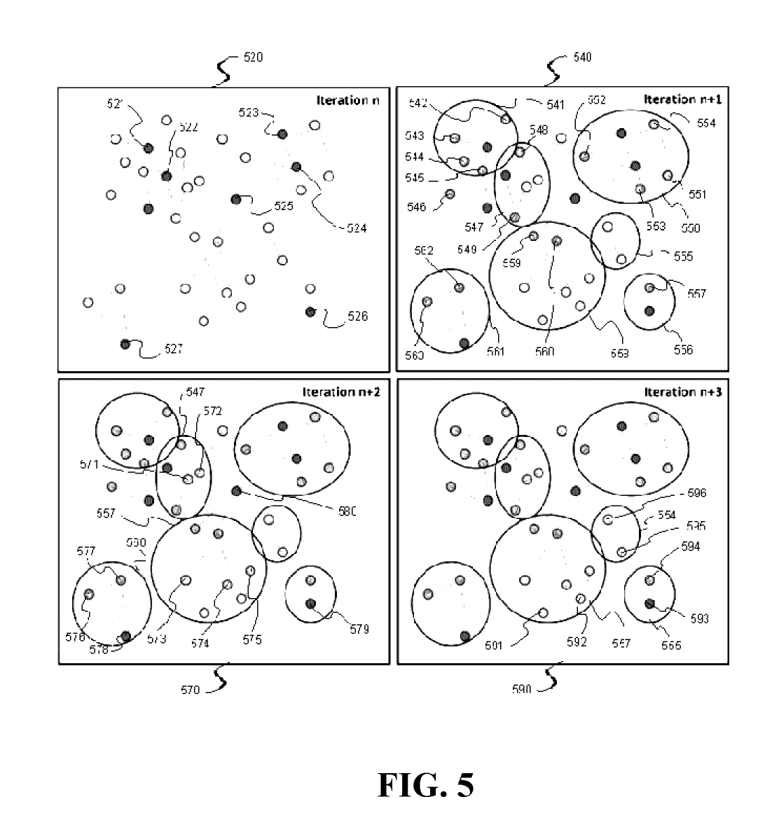

FIG. 5 illustrates an example iterative protein clustering and functional characterization. Starting from the PPIN previously described, at iteration (n) 520 a function is assigned to those proteins 521-527 for which functional data is available experimentally or computationally. The remaining proteins still have no functional characterization.

In the next iteration (n+1) 540 seven protein clusters are created 541, 547, 550, 555, 556, 558, 561 based on any of the previously presented methodologies. Cluster 541 contains five proteins including the protein 521 functionally characterized in iteration (n) 520, and the proteins 542-545 that are each assigned a functionality in the present iteration (n+1) 540.

Cluster 547 contains five proteins, the protein 522 that was previously functionally characterized in the previous iteration (n) 520, two proteins 548, 549 that are functionally characterized in the present iteration (n+1) 540, and two proteins that remain functionally uncharacterized after the completion of the present iteration (n+1) 540.

Cluster 550 contains six proteins, two proteins 523, 524 previously characterized in iteration (n) 520 and proteins 551-554 that are functionally characterized in the present iteration (n+1) 540.

Cluster 555 contains two proteins without any assigned functionalities.

Cluster 556 contains two proteins, the protein 526 functionally characterized in iteration (n) 520 and the protein 557 which is assigned a functionality in the present iteration (n+1) 540.

Cluster 558 contains seven proteins, with no functional characterization in the previous iteration (n) 520 but with a function assigned to each of two proteins 559, 560. The remaining four proteins remain without any functional characterization after the completion of the present iteration (n+1) 540.

Cluster 561 contains three proteins, the protein 527 that has been assigned a functionality in iteration (n) 520, and the two proteins 562, 563 that are assigned a functionality each in the present iteration (n+1) 540.

During the following iterations, the clusters 541, 547, 550, 555, 556, 558, 561 that were created in iteration (n+1) 540 remain unaltered in their number and protein members.

In iteration (n+2) 570 three types of functional assignments are made. Functional assignments made to clustered proteins (571, 572), (573, 574, 575) that were previously functionally unassigned in the previous iterations 520, 540, new functional assignments to clustered and previously functionally characterized proteins (576, 577, 578), (579), and functional assignments to un-clustered proteins 580.

In iteration (n+3) 590 functional assignments are made to previously functionally characterized proteins (591, 592), (593, 594). The remaining previously functionally uncharacterized proteins (e.g. 593, 594) are unaltered, while some proteins (595, 596) still remain functionally uncharacterized.

More iterations may follow until either all proteins have been functionally characterized, or until no new characterizations are made. Alternative exemplary embodiments may include variations of this method. By means of example and without limiting the scope of the invention, alternative embodiments may comprise variations comprising stopping iterations when a maximum number or multiple functional assignments are made to any of the proteins and no uncharacterized proteins remain or when the scores of the new functional assignments in an iteration are below a predefined threshold.

In yet another embodiment, the termination criteria are even more flexible and the algorithm terminates if the percentage of newly characterized proteins in the current iteration over the proteome size is below a predefined threshold.

In yet another exemplary embodiment, an additional step is added for checking the results of the method. If the percentage of proteins with no assigned functionalities and/or topologies is above a second threshold, then the method may be iterated using different classifications (i.e. re-clustering) and/or confidence scoring and ranking. At the end of a predefined number of iterations or when no unassigned proteins remain this specific embodiment terminates.

In yet another embodiment the confidence score assigned for each annotation characterization consists of two parts. The first part indicates the depth of the term in the ontological annotation term description and the second part, which ranges from (0-1], consists of the c score described in equations 1-3.

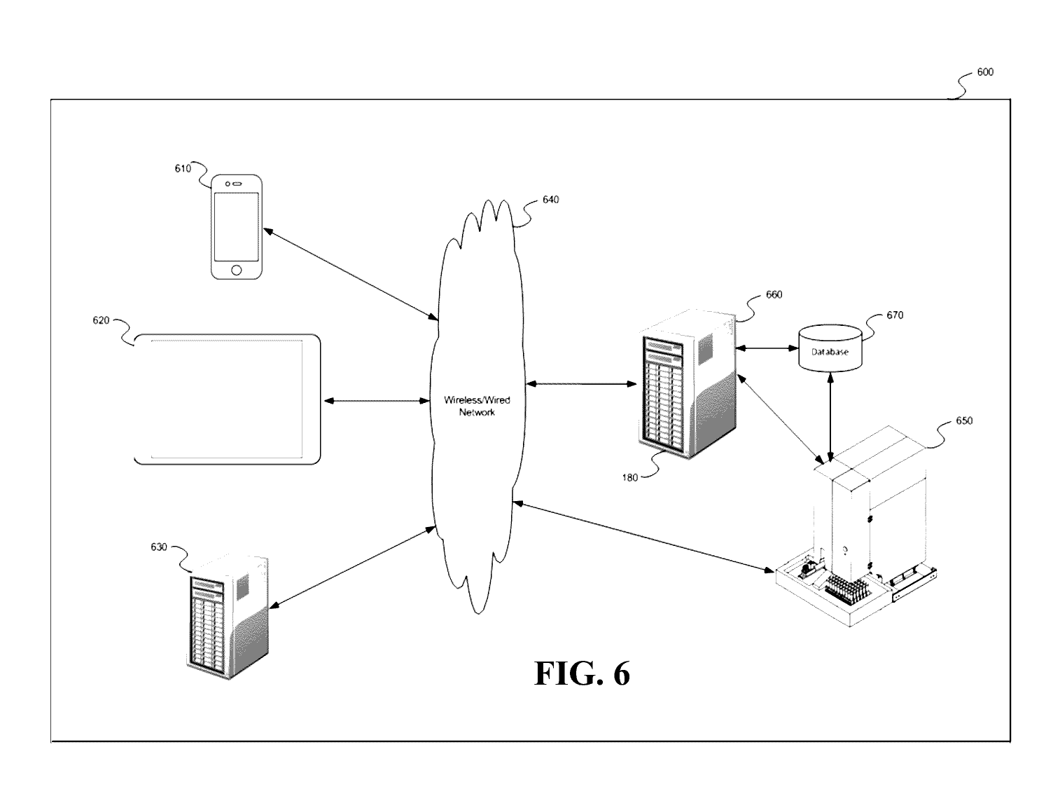

FIG. 6 shows a system implementing the present invention. A user may use a number of computing devices, like a mobile phone 610, a tablet 620 with networking capabilities, or a networked desktop or laptop computer 630, and access via a wired or wireless network 640, a server 660 which provides access to a database 670 holding experimental and computational results used in the present invention. In an alternative embodiment, the user's devices, may access a biological data analyzer unit 650, which provides experimental results on the said biological data. The biological data analyzer stores its data either directly to the database 670 or via the server 660.

The processing and calculations used in the implementation of the present invention are done at the server 660, the analyzer 650, the mobile devices 610, 620, 630, one or more distributed computing devices not shown (e.g. cloud infrastructure, remote servers of other computing devices, etc.), or any combination of these.

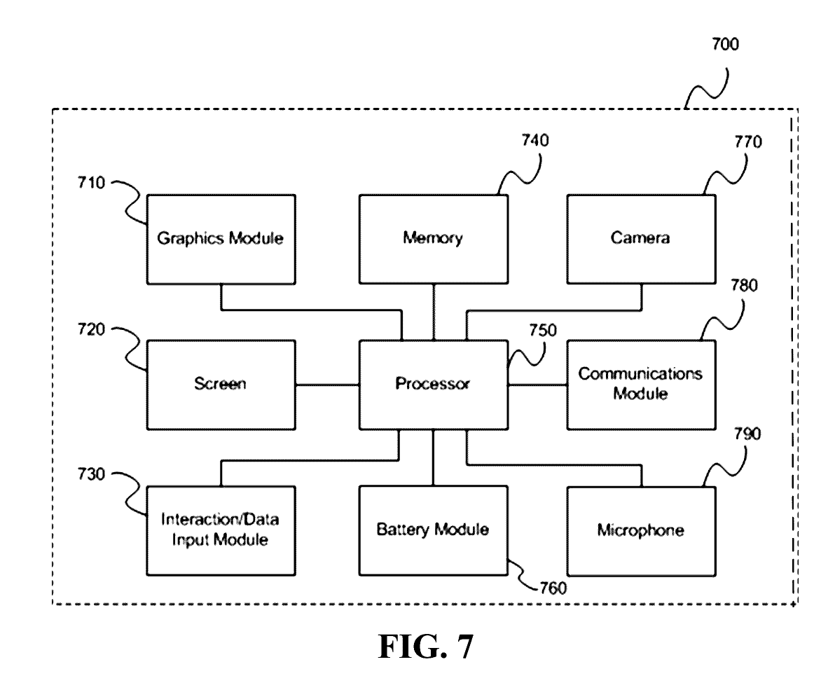

FIG. 7 shows the architecture of a device (660, 650, 610, 620, 630, etc.), which implements the invention or part or parts of the invention. The device 700 comprises a Processor 750 upon which a Graphics Module 710, a Screen 720 (in some exemplary embodiments the screen may be omitted), an Interaction/Data Input Module 730, a Memory 740, a Battery Module 760, a Camera 770 (in some exemplary embodiments the screen may be omitted), a Communications Module 780, and a Microphone 790 (in some exemplary embodiments the microphone may be omitted).

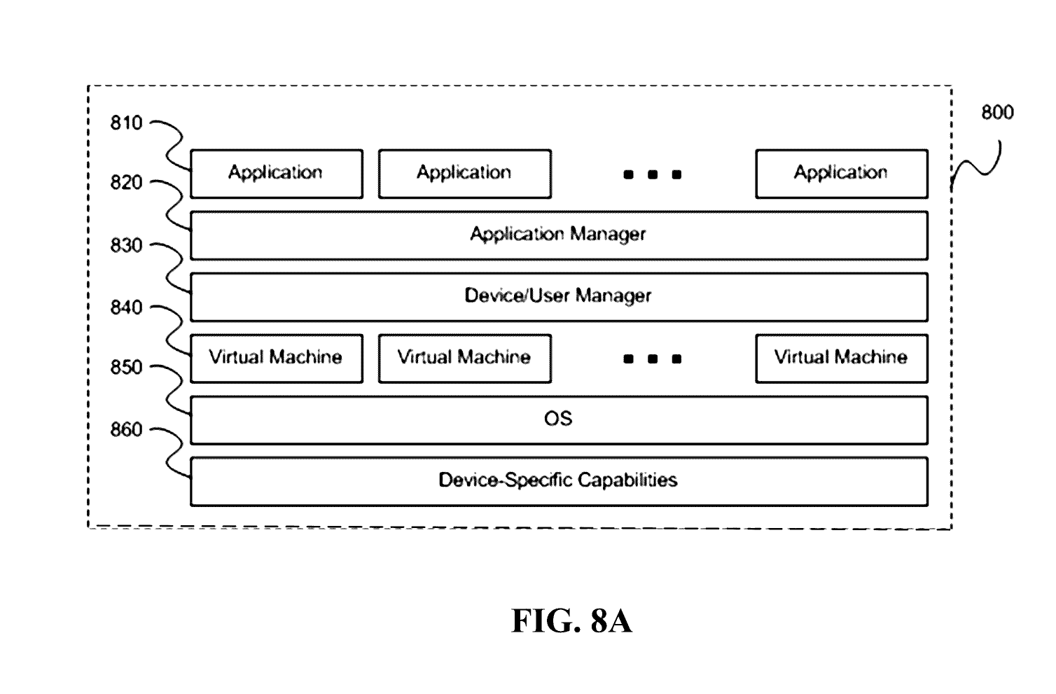

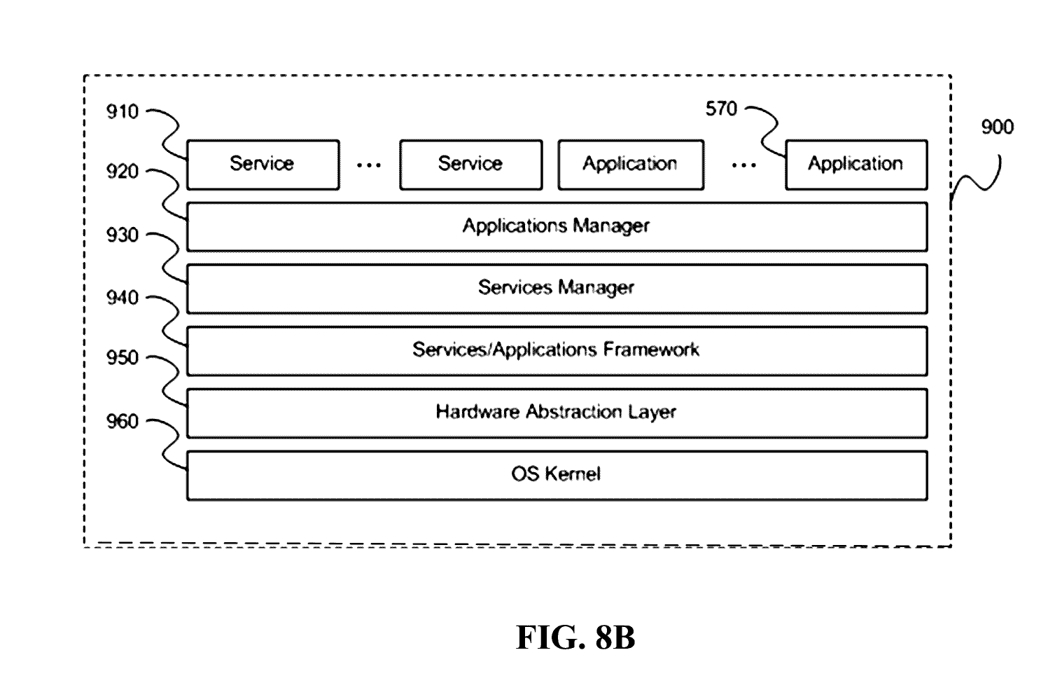

FIG. 8A shows the main Software Components of a mobile device. At the lowest layer are the Device-Specific Capabilities 860, that is the device-specific commands for controlling the various device hardware components. Moving to higher layers lie the OS 850, Virtual Machines 840 (like a Java Virtual Machine), Device/User Manager 830, Application Manager 820, and at the top layer, the Applications 810. These applications may access, manipulate and display data.

FIG. 8B shows the main Software Components of a Server. At the lowest layer is the OS Kernel 960 followed by the Hardware Abstraction Layer 950, the Services/Applications Framework 940, the Services Manager 930, the Applications Manager 920, and the Services 910 and Applications 970.

It is noted, that the software and hardware components shown in FIG. 7, FIG. 8A and FIG. 8B are by means of example and other components may be present but not shown in these Figures, or some of the displayed components may be omitted.

The present invention may also be implemented by software running at the server 660, the analyzer 650, the mobile devices 610, 620, 630, one or more distributed computing devices not shown (e.g. cloud infrastructure, remote servers of other computing devices, etc.), or any combination of these. It may be implemented in any computing language, or in an abstract language (e.g. a metadata-based description which is then interpreted by a software or hardware component). The software running in the above mentioned hardware, effectively transforms a general-purpose or a special-purpose hardware or computing device, system into one that specifically implements the present invention.

A simple practical example use of the invention is its application in the Human organism. First, an initial dataset was constructed using HPRD known protein-protein interactions as positive set and random protein pairs which have not been referred as interactions in iRefindex database. iRefindex database includes protein-protein interactions integrated from various other databases. 22 informative features were calculated for every protein pair in the dataset. These features are: number of common GO molecular function terms, number of common GO molecular process terms, number of common GO cellular compartment terms, number of interacting domains, 15 different co-expression profiles similarities from 15 different expression experiments, sequence similarity, the existence or not of an orthologue interaction in Yeast organism, co-localization predicted with PLST tool. A machine learning model was then trained using a methodology called EvoKALMAModel. The trained model was applied to predict protein-protein interactions examining all possible combinations of proteins to protein pairs. Additionally, a confidence score (taking values from 0-1) was computed for every predicted protein-protein interaction. 15604 unique proteins where considered in this analysis and 211367 protein-protein interactions where predicted among them.

The predicted protein-protein interactions and their confidence scores were utilized according to the invention to form a protein-protein interaction network with edges' weights being equal to the confidence score of the corresponding interactions.

GO terms were used for the initial molecular function, biological process and cellular compartment annotation of proteins (Gene Ontology repository was accessed on 1 Nov. 2016 in this example application of the current invention). The initial functional annotation with data from Gene Ontology included 47.78% molecular function term annotation, 67.13% biological process term annotation and 50.13% cellular compartment term annotation.

Moreover, a clustering algorithm was applied to the protein-protein interaction network predicting 764 protein clusters with 72.58% of them being enriched with at least one molecular function specific term filtering out generic terms such as DNA binding and RNA Binding which characterize a large number of proteins. By functionally characterizing proteins which participate in functionally enriched clusters the percentage of functionally characterized proteins were risen to 57.74% for molecular function term, 74.53% for biological process term and 58.29% for cellular compartment term.

By applying the step 1.3 of the main algorithmic framework of the invention this knowledge was expanded with all proteins being functionally characterized. The confidence score threshold for canceling a functional assignment was set to 0.1. It is noteworthy that some proteins have been proven to be characterized with more than 10 different molecular functions showing that the overall methodology was also able to handle proteins with multiple functionalities.

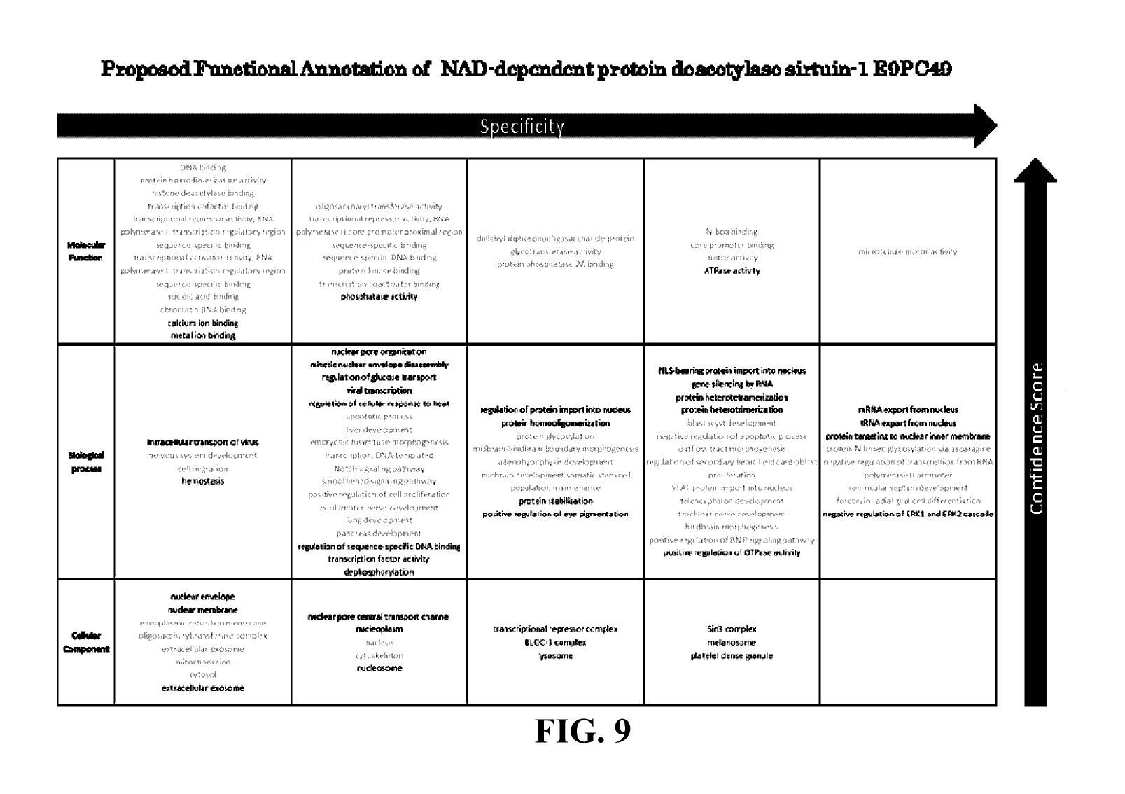

FIG. 9 presents, for exemplary purposes, the final functional annotation of NAD-dependent protein deacetylase sirtuin-1 with uniprot-ID E9PC49 which was previously annotated with none of the molecular function, biological process and cellular compartment terms in the gene ontology repository. The scoring extension method described in paragraph [00106] was used to provide the annotation results in a more meaningful manner. The example of E9PC49 indicated the importance of the described pipeline as it allowed the full functional characterization of this un-annotated protein. Moreover, the aforementioned annotation revealed with high confidence the role of this protein in transferring viruses to the nucleus of a cell which comes into agreement with the cellular component annotation which was exported. Moreover, the utilized scoring scheme is able to allow researchers study the functional annotation of molecules in many levels: term specificity, term type and confidence of a functional annotation assignment. Additionally, to better present the results, the confidence score of the annotations was used as follows: the specificity of the term was presented in the annotations starting from more general terms to less general terms and the actual score was depicted with different colors (from intense for scores [0.7-1] to mild for scores from 0.1-0.3).

The above exemplary embodiments are intended for use either as a standalone user identification method in any conceivable scientific and business domain, or as part of other scientific and business methods, processes and systems.

The above exemplary embodiment descriptions are simplified and do not include hardware and software elements that are used in the embodiments but are not part of the current invention, are not needed for the understanding of the embodiments, and are obvious to any user of ordinary skill in related art. Furthermore, variations of the described method, system architecture, and software architecture are possible, where, for instance, method steps, and hardware and software elements may be rearranged, omitted, or new added.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

In one or more exemplary embodiments, the functions described may be implemented in hardware, software, firmware, or any combination thereof. If implemented in software, the functions may be stored on or transmitted over as one or more instructions or code on a computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or any other device or apparatus operating as a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of predicting the functionality of the proteome of an organism, comprising:
constructing a plurality of interacting protein pairs, where said plurality of interacting protein pair are either weighted or un-weighted;
assigning a first set of functionalities to proteins in said protein pairs, where each protein is assigned either at least one functionality or no functionality;
clustering said proteins into at least one cluster using at least a first criterion;
iteratively assigning at least a second set of functionalities to the proteins of the at least one cluster, where said second assignment is done by pairwise comparison of all interacting proteins in a cluster and where the first protein is assigned at least one functionality of the second protein, or no assignment is made if the second protein has no assigned functionality, and the second protein is assigned at least one functionality of the first protein, or no assignment is made if the first protein has no assigned functionality, and where said assignment of the second set of functionalities continues until either all proteins of said proteome have been assigned at least one functionality or no new functionality assignment can be made;
assigning confidence values to said functionality assignments;
comparing said confidence values with a first threshold; and
keeping said confidence values that are larger or equal to the first threshold and rejecting said confidence values that are smaller than the first threshold.

2. The method of claim 1, where the iterative assignment of the second set of functionalities continues until one of the following conditions is true:
a maximum number or multiple functional assignments are made to any of the proteins and no uncharacterized proteins remain;
the scores of the new functional assignments in an iteration are below a predefined threshold; and
the percentage of newly characterized proteins in the current iteration over the proteome size is below a second threshold.

3. The method of claim 1, where at the least first criterion comprises one of the following or a combination of at least two of the following:
distance of the first protein to the second protein;
2D or 3D molecular similarity; and
common segments of biological molecules;

4. The method of claim 1, where the confidence value of each functionality assignment for the first protein is calculated by one of the following:
if this is the first assignment of functionality to said first protein and if a single second criterion is used in the assignment of functionalities to the interacting proteins, setting the confidence value equal to “1” for each assignment;
if this is the first assignment of functionality to said first protein and if more than one second criterion is used in the assignment of functionalities to the interacting proteins, setting the confidence value equal to the result of adding “0.9” to the result of multiplying “0.1” by the result of the division of the number of different second criteria used in said assignment of functionality by the total number or unique second criteria used in all assignments of functionality in all said clusters;
if this is not the first assignment of functionality to said first protein, setting the confidence value equal to the result of dividing the confidence value for the previous functionality assignment for said first protein by the result of adding “1” to “A”, where “A” is a positive number; and
if this is not the first assignment of functionality to said first protein and if the plurality of interacting protein pairs are weighted, setting the confidence value equal to the result of multiplying the confidence value of the second protein, which said second protein in paired with said first protein, by the weight of the interaction of the pair of said first and second proteins, and where the second protein has been assigned a functionality in the previous iteration.

5. The method of claim 1, where said functionality is replaced or complemented by topology in biological cells, where said topology comprises sub-cell structures and/or cell types.

6. The method, of claim 1, further comprising ordering the assigned functionalities using one or a combination of at least two in any order of the following:
assigned confidence values;
specificity of said functionalities;
functionalities; and
topologies.

7. The method of claim 1, where said interacting protein pairs are replaced by one of the following or by a combination of at least two of the following:
gene co-expression pairs;
genetic interaction pairs;
gene regulatory pairs; and
metabolic pairs.

8. The method of claim 7, where for gene co-expression pairs and/or genetic interaction pairs, the method further comprising:
mapping genes on the proteins that said genes produce when said genes are expressed.

9. The method of claim 7, where for gene regulatory pairs and/or metabolic pairs, functionality assignments are directed in the direction of said regulatory pairs and/or said metabolic pairs.

10. The method of claim 1, where the iterative assignment of the at least second set of functionalities to said proteins continues until the percentage of proteins with no assigned functionalities is above a third threshold, the method further comprising:
re-clustering said proteins into at least one cluster using at least a third criterion; and
iterating for a predefined number of iterations, or until none of said proteins remains without a functionality assignment.

11. The method of claim 1, where the un-weighted interacting protein pairs are a Protein-Protein Interaction Network and the weighted interacting protein pairs are a Protein-Protein Interaction Graph.

12. The method of claim 7, where the:
gene co-expression pairs are gene co-expression networks;
genetic interaction pairs are genetic networks;
gene regulatory pairs are gene regulatory networks; and
metabolic pairs are metabolic networks.

13. In a computing device, a method of identifying the likely functionality annotation of individual proteins from collected data, comprising:
(i) creating a plurality of interacting protein pair associations from the collected data;
(ii) for each identified interacting protein pair association, identifying when one of the proteins in a pair has a functionality annotation that is not known;
(iii) assigning a likely functionality annotation to each protein in a protein pair association with an unknown functionality annotation that matches the functionality annotation of the other protein in each corresponding protein pair association;
(iv) separating the plurality of interacting protein pair associations into clusters of matching functionality annotations; and
(v) for each cluster, reiteratively repeating steps (ii) and (iii) until there are no more protein pair associations with either an originally known functionality annotation or a likely functionality annotation paired with a protein with an unknown functionality annotation.

14. The method of claim 13, further comprising determining a ranking on the basis of specificity and confidence information for each assignment and removing any likely functionality associations as a function of the ranking.

15. A computing device configured to predict the functionality of the proteome of an organism, the computing device or system or biological analyzer comprising:
means for constructing a plurality of interacting protein pairs, where said plurality of interacting protein pair are either weighted or un-weighted;
means for assigning a first set of functionalities to proteins in said protein pairs, where each protein is assigned either at least one functionality or no functionality;
means for clustering said proteins into at least one cluster using at least a first criterion;
means for iteratively assigning at least a second set of functionalities to the proteins of the at least one cluster, where said second assignment is done by pairwise comparison of all interacting proteins in a cluster and where the first protein is assigned at least one functionality of the second protein, or no assignment is made if the second protein has no assigned functionality, and the second protein is assigned at least one functionality of the first protein, or no assignment is made if the first protein has no assigned functionality, and where said assignment of the at least second set of functionalities continues until either all proteins of said proteome have been assigned at least one functionality or no new functionality assignment can be made;
means for assigning confidence values to said functionality assignments;
means for comparing said confidence values with a first threshold; and
means for keeping said confidence values that are larger or equal to the first threshold and rejecting said confidence values that are smaller than the first threshold.

16. The computing device of claim 15, where said functionality is replaced or complemented by topology in biological cells, where said topology comprises sub-cell structures and/or cell types.

17. The computing device of claim 15, further comprising means for ordering the assigned functionalities using one or a combination of at least two in any order of the following:
assigned confidence values;
specificity of said functionalities;
functionalities; and
topologies.

18. The computing device of claim 15, where the means for iteratively assigning the at least second set of functionalities to said proteins continues until the percentage of proteins with no assigned functionalities is above a third threshold, the method further comprising:
means for re-clustering said proteins into at least one cluster using at least a third criterion; and
means for iterating for a predefined number of iterations, or until none of said proteins remains without a functionality assignment.

19. A non-transitory computer program product that causes a computing device to predict the functionality of the proteome of an organism, the non-transitory computer program product having instructions to:
construct a plurality of interacting protein pairs, where said plurality of interacting protein pair are either weighted or un-weighted;
assign a first set of functionalities to proteins in said protein pairs, where each protein is assigned either at least one functionality or no functionality;
cluster said proteins into at least one cluster using at least a first criterion;
iteratively assign at least a second set of functionalities to the proteins of the at least one cluster, where said second assignment is done by pairwise comparison of all interacting proteins in a cluster and where the first protein is assigned at least one functionality of the second protein, or no assignment is made if the second protein has no assigned functionality, and the second protein is assigned at least one functionality of the first protein, or no assignment is made if the first protein has no assigned functionality, and where said assignment of the at least second set of functionalities continues until either all proteins of said proteome have been assigned at least one functionality or no new functionality assignment can be made;
assign confidence values to said functionality assignments;
compare said confidence values with a first threshold; and
keep said confidence values that are larger or equal to the first threshold and reject said confidence values that are smaller than the first threshold.

20. The non-transitory computer program product of claim 19, where said functionality is replaced or complemented by topology in biological cells, where said topology comprises sub-cell structures and/or cell types.

21. The non-transitory computer program product of claim 19, further comprising instructions to order the assigned functionalities using one or a combination of at least two in any order of the following:
assigned confidence values;
specificity of said functionalities;
functionalities; and
topologies.

22. The non-transitory computer program product of claim 19, where the iterative assignment of the at least second set of functionalities to said proteins continues until the percentage of proteins with no assigned functionalities is above a third threshold, further comprising instructions to:
re-cluster said proteins into at least one cluster using at least a third criterion; and
iterate for a predefined number of iterations, or until none of said proteins remains without a functionality assignment.
